(19) United States
(12) Patent Application Publication
(10) Pub. No.: US 2026/0284574 A1
(43) Pub. Date: Sep. 24, 2026

(54) APPARATUS, SYSTEM AND METHOD FOR PROCESSING EXHAUST GAS

(71) Applicant: Taiwan Semiconductor Manufacturing Company, Ltd., Hsinchu (TW)

(72) Inventors: Chyi-Tsong NI, Hsinchu (TW); Che-Yu Chiang, Taipei City (TW); Tse-Hsien Wu, Keelung City (TW)

(73) Assignee: Taiwan Semiconductor Manufacturing Company, Ltd., Hsinchu (TW)

(21) Appl. No.: 19/086,172

(22) Filed: Mar. 21, 2025

(51) Int. Cl. B01D 53/04; B01D 53/14; B01D 53/96; B01J 27/18

(52) U.S. Cl. CPC B01D 53/0462; B01D 53/14; B01D 53/96; B01J 27/1802; B01D 2255/20; B01D 2255/50

(57) ABSTRACT

An apparatus for processing an exhaust gas includes reaction chamber, rotary plate, first, second and third separation plates, catalysts, heater, sprayers and fluid tank. The rotary plate is disposed in reaction chamber and has through holes penetrating through the rotary plate. The first, the second and the third separation plates are disposed in the reaction chamber and disposed uprightly on the rotary plate to define and segregate a first, a second and a third divisions in the reaction chamber and a first, a second and a third division areas on the rotary plate. The connecting pipe connects the first and the second divisions. The catalysts are distributed on the rotary plate, the heater is disposed inside the second division, and the sprayers are disposed in the third division. The fluid tank is for supplying the regenerating agent into the third division over the catalysts in the third division area.

### BACKGROUND

Various types of gases are used during semiconductor manufacturing processes, and the handling of reaction gases and exhaust gases is important.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic view illustrating an apparatus for processing exhaust gas in accordance with some embodiments of the disclosure.

FIG. 1B is a schematic top view showing exemplary structures of the rotary plate, the separation plates, and the catalysts of FIG. 1A.

FIG. 1C is a schematic perspective view showing exemplary structures of the rotary plate the hollow pole, the separation plates, the catalysts, the heater, and spray nozzles of FIG. 1A.

FIG. 1D is a schematic side view of FIG. 1A.

FIG. 1E is a schematic top view illustrating an apparatus for processing exhaust gas accordance with some embodiments of the disclosure.

FIG. 2 is a schematic view illustrating an apparatus for processing exhaust gas in accordance with some embodiments of the disclosure.

FIG. 3A is a schematic view illustrating a system for processing exhaust gas in accordance with some embodiments of the disclosure.

FIG. 3B is a schematic top view illustrating the arrangement of the system in FIG. 3A.

FIG. 4 is a schematic view illustrating a system for processing exhaust gas in accordance with some embodiments of the disclosure.

FIG. 5 is the flow chart showing the steps of the method for processing exhaust gas according to some exemplary embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “substantially” in the description, such as in “substantially flat” or in “substantially coplanar”, etc., will be understood by the person skilled in the art. In some embodiments the adjective substantially may be removed. Where applicable, the term “substantially” may also include embodiments with “entirely”, “completely”, “all”, etc. Where applicable, the term “substantially” may also relate to 90% or higher, such as 95% or higher, especially 99% or higher, including 100%. Furthermore, terms such as “substantially parallel” or “substantially perpendicular” are to be interpreted as not to exclude insignificant deviation from the specified arrangement and may include for example deviations of up to 10°. The word “substantially” does not exclude “completely” e.g., a composition which is “substantially free” from Y may be completely free from Y.

Some embodiments of the disclosure are described. Additional operations can be provided before, during, and/or after the stages described in these embodiments. Some of the stages that are described can be replaced or eliminated for different embodiments. Additional features can be added to the semiconductor device structure. Some of the features described below can be replaced or eliminated for different embodiments. Although some embodiments are discussed with operations performed in a particular order, these operations may be performed in another logical order.

For handling reaction chemicals, exhaust gases and waste gases, scrubber apparatuses or systems are widely used. Within the scrubber system, high energy may be applied along with catalyst for treating the chemical gas(es). It is suggested that the catalyst(s) can enhance chemical/gas treatment efficiency by effectively lowering the activation energy of bond breaking for the treated gas, thereby saving energy consumed in gas processing and lowering production costs. During the gas treatment processes, catalyst poisoning and/or the clogging of the catalysts by powders and aggregates carried by the gas will result in low reaction rates and incomplete reaction/treatment of the gas (e.g. the incomplete treatment of the exhaust gas), leading to inefficient operation or fabrication, higher production costs or even environmental issues.

In some embodiments, a scrubber device/apparatus is described and provided with the design of recyclable catalyst(s) for efficiently treating byproduct gas(es), exhaust gas(es) and greenhouse gas(es). By solving the issues including catalyst poisoning and/or catalyst clogging, the exhaust gas or waste gas generated during semiconductor manufacturing processing can be treated effectively and completely under lower thermal budgets. Herein, the so-called catalyst poisoning refers to the partial or fully deactivation of the catalyst, so that the catalyst is unable to adsorb/absorb and react with the to-be-treated gas. Upon the adsorption or absorption of the chemical or gas onto or into the catalysts, the catalysts gradually become saturated and finally are deactivated. In order to recycle the catalysts, the catalysts need to be reactivated by a high energy process (such as a thermal process or a plasma treatment) and/or through an external chemical agent (i.e. a reactivating agent or regenerating agent). In some embodiments, a rotary catalyst plate with a plurality of segregated areas is provided, which allows the catalysts on the rotary plate to be recycled by continuously going through chemical/gas adsorption, chemical/gas desorption, and reactivation (catalytic activity regeneration), thus solving the problem of catalyst poisoning.

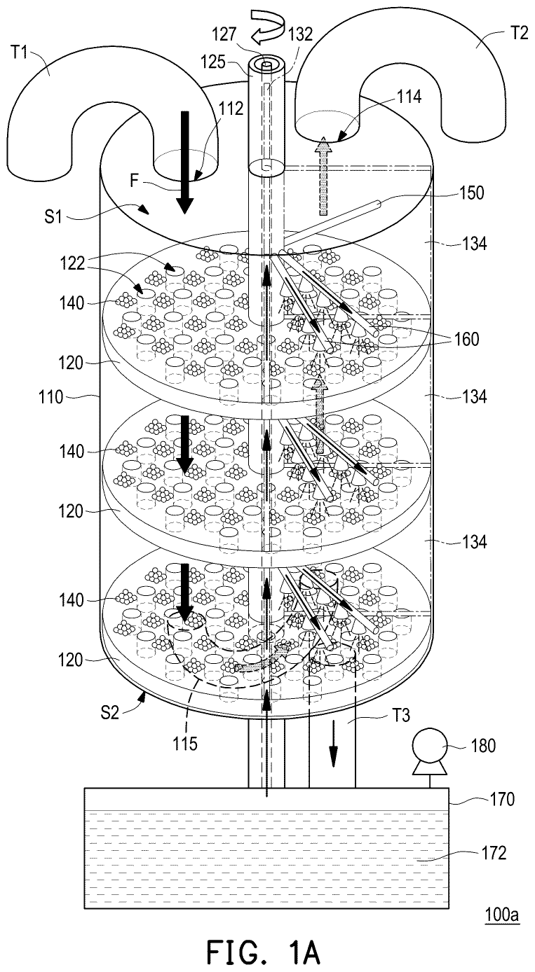

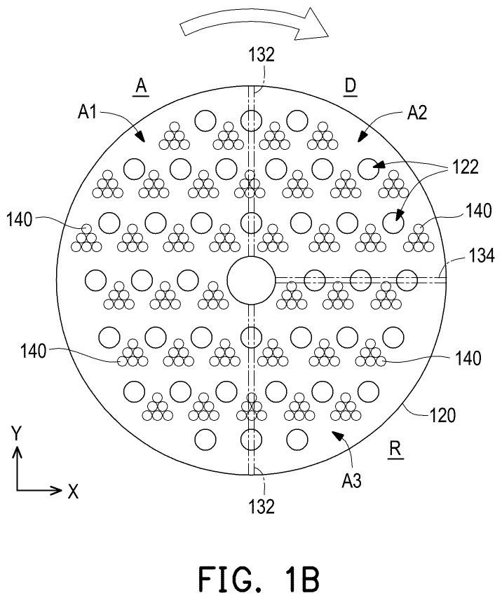

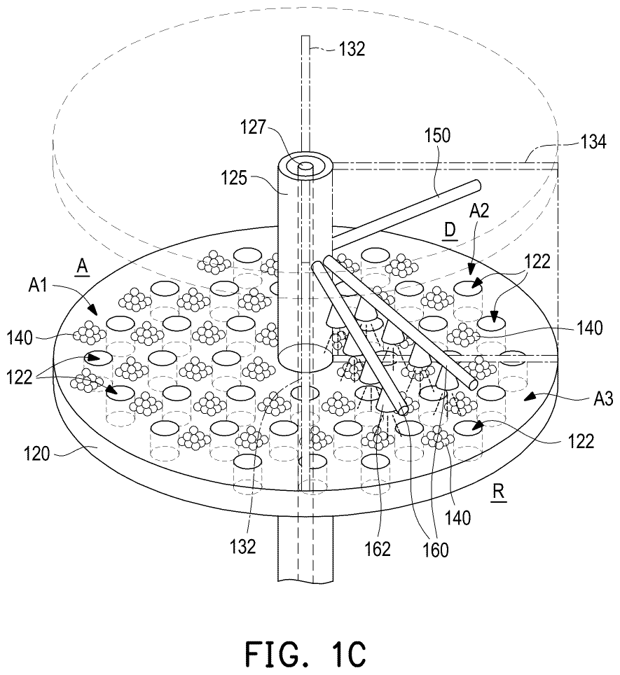

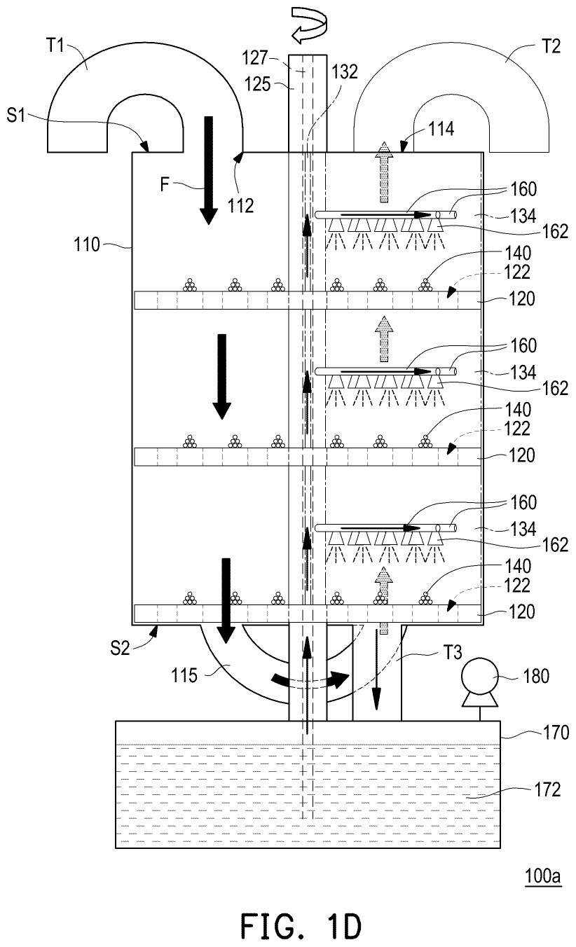

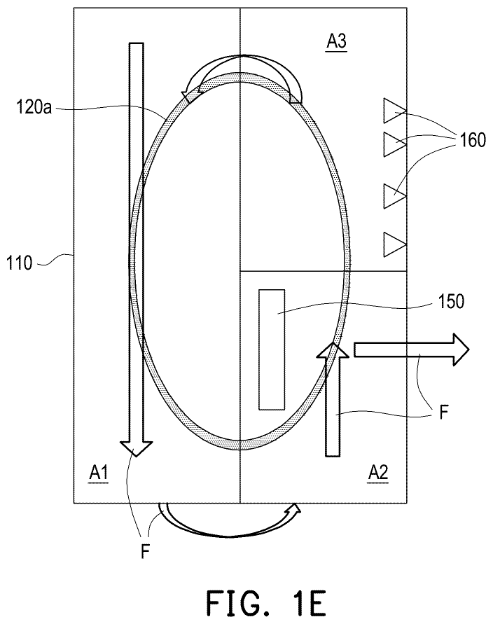

FIG. 1A is a schematic view illustrating an apparatus for processing exhaust gas in accordance with some embodiments of the disclosure. FIG. 1B is a schematic top view showing exemplary structures of the rotary plate, the separation plates, and the catalysts of FIG. 1A. FIG. 1C is a schematic perspective view showing exemplary structures of the rotary plate, the hollow pole, the separation plates, the catalysts, the heater, and spray nozzles of FIG. 1A. FIG. 1D is a schematic side view of FIG. 1A. For illustration purposes, the reaction chamber 110 is depicted as being transparent to show the interior arrangements of the rotary plates 120 and the catalysts 140, and the separation plates 132, 134 in FIG. 1A to FIG. 1D are represented by dashed lines.

Referring to FIG. 1A to FIG. 1D, an apparatus 100a for processing exhaust gas F (represented by bolded arrows) includes a reaction chamber 110, one or more rotary plates 120, a plurality of separation plates 132, 134, catalysts 140, a heater 150, a plurality of sprayers 160, a recycling fluid tank 170 and a pump 180. In some embodiments, the apparatus 100a is or includes a scrubber device/apparatus for removing undesirable ingredients from the exhaust gases. In some embodiments, the apparatus 100a is a catalyst-type scrubber device/apparatus, and the apparatus 100a utilizes one or more types of catalysts for assisting the removal of the undesirable gases. In some embodiments, the exhaust gas F is or includes, gas exhausted from microfabrication or semiconductor processing of a semiconductor wafer. Depending on the type of semiconductor processing step(s) performed, when the microfabrication step is completed, residual reaction gases and byproduct gases generated during the processing (i.e. microfabrication step) will be exhausted out of the processing tool chamber (microfabrication tool chamber) and the exhaust gas will be treated by the apparatus for processing exhaust gas. In some embodiments, the apparatus 100a is a local scrubber device/apparatus connected to an etching chamber, and the exhaust gas F, for example, is the exhaust gas from the etching process performed in the etching chamber, including fluorinated gases or perfluorocarbon (PFC) gases, such as CF₄, C₂F₆, C₃F₈, C₄F₈, etc. In some embodiments, the apparatus 100a is a local scrubber device/apparatus connected to a deposition chamber, and the exhaust gas F, for example, is the exhaust gas exhausted from film deposition and cleaning processes used for thin film manufacturing (such as chemical vapor deposition (CVD)) in the deposition chamber, including nitrogen-containing greenhouse gases, such as nitrous oxide (N₂O), nitrogen trifluoride (NF₃), etc.

In some embodiments, the reaction chamber 110 has a cylindrical tower shape with a central axis extending vertically (substantially perpendicular to the ground plane). As seen in FIG. 1A, the reaction chamber 110 has a first side (top side) S1 and a second side (bottom side) S2 opposite to the first side S1, an inlet 112 and an outlet 114 located at the first side S1, and a connecting pipe 115 at the second side S2. In FIG. 1A, three rotary plates 120 are disposed inside the reaction chamber 110, stacked upon one another but spaced apart from the adjacent one with substantially the same distance, and arranged at intervals in three levels vertically to divide the chamber into three parts. In some embodiments, the rotary plate 120 has a circular or oval shape (conforming with the cross-sectional shape of the chamber). For example, each of the rotary plates 120 has a plurality of through holes 122 penetrating through the rotary plate 120 (in the thickness direction). In some embodiments, less than three or more than three rotary plates 120 may be included, it is understood that the shape and the number of the rotary plates 120 are merely exemplary and not intended to limit the scope of the disclosure. In some embodiments, the through holes 122 are evenly dispersed over the rotary plate 120, the through holes 122 passing through the rotary plate 120 are designed to facilitate gas flow and even gas distribution over the plate surface to increase the contact with the catalysts 140. In some embodiments, the through holes 122, for example, include circular or oval through holes or polygonal shaped holes. The numbers, the arrangement and the shapes of the through holes 122 are merely exemplary and are not intended to limit the scope of the disclosure. In some embodiments, a total area of all the through holes 122 over the area of the rotary plate 120 is about or greater than 10% (i.e. 10% of the area of the rotary plate 120). In some embodiments, each of the through holes 122 has a diameter greater than about 1 mm. That is, at least one of the rotary plates 120 is designed as a multi-hole plate. In some embodiments, a material of the rotary plate 120 includes stainless steel, nickel-based alloys or other metal alloys or a combination thereof. Herein, it is possible that the rotary plates 120 are positioned in the reaction chamber 110 with different intervals or stacked upon each other, and the thickness and the size of the rotary plate 120 are not particularly limited as long as they are able to support the catalysts 140 and work under the gas flow.

In FIG. 1A and FIG. 1C, the apparatus 100a for processing exhaust gas F further includes a hollow pole 125 disposed in the reaction chamber 110, passing through the center of the individual rotary plates 120 to support and position the rotary plates 120 within the reaction chamber 110. The rotary plates 120 are rotated by way of any rotation mechanism, and the rotation direction is represented by the hollow arrow shown in FIG. 1A and FIG. 1D. In some embodiments, a fluid pipe 127 is arranged within the hollow pole 125 to deliver the fluid containing the reactivating agent(s) for the sprayers 160. It is understood that additional wires and/or pipes may be arranged inside the hollow pole 125. The reaction chamber 110 is separated by separation plates 132, 134 fixed to the sidewall(s) of the hollow pole 125 into nine parts or nine divisions. In some embodiments, among the space between two most adjacent rotary plates 120, two separation plates 132 and one isolation plate 134 divide the space into three parts or three divisions A, D, R. In some embodiments, as seen in FIG. 1B, the extending direction (Y-direction) of the separation plates 132 is different from the extending direction (X-direction) of the isolation plate 134. In some embodiments, the extending direction (Y-direction) of the separation plates 132 is perpendicular to the extending direction (X-direction) of the isolation plate 134. From the schematic top view of the rotary plate 120 in FIG. 1B, for each rotary plate 120, a first division area A1 is defined between the two separation plates 132, and a second division area A2 and a third division area A3 are respectively defined between the isolation plate 134 and the upper and lower separation plates 132. In some embodiments, referring to FIG. 1B and FIG. 1C, considering the space between the adjacent rotary plates 120, a first division A (above the first division area A1) is defined between the two separation plates 132, a second division D (above the second division area A2) is defined between the isolation plate 134 and the upper separation plate 132, and a third division R (above the third division area A3) is defined between the isolation plate 134 and the lower separation plate 132 in the reaction chamber 110. For the gas treatment upon the catalysts 140, the gas confined in the first division A is adsorbed/absorbed to and reacted with the catalysts 140 within the first division area A1, and the first division area A1 is an adsorption/reaction area, the second division area A2 is a desorption area, and the third division area A3 is a reactivation area, for the catalysts 140.

In some embodiments, the location of the inlet 112 may be arranged at a location open to the space right above the first division area A1, and the location of the outlet 114 may be arranged at a location open to the space right above the second division area A2. In some embodiments, the heater 150 is arranged within the space of the second division D right above the second division area A2, and the sprayers 160 are arranged within the space of the third division R right above the third division area A3. The divisions A, D, R segregated by the separation plates 132, 134 are air-tight and sealed so that gases within different divisions are not intermingled, and the gas coming from the inlet 112 shall flow to the other division through the through holes 122 and the pipe 115 following the flow direction (the bolded arrows) and flow out from the outlet 114. In some embodiments, the sealing of the divisions is achieved by using sealant, seal rings, rubber strips or other means.

In some embodiments, the first division area A1 is larger than the second division area A2, while the second division area A2 is about the same or equal to the third division area A3. In some embodiments, within the round rotary plate 120, the first division area A1 is, for example, a semicircular region, while the second division area A2 and the third division area A3 are, for example, quarter-circular regions, respectively.

During the rotation of the rotary plates 120, the reaction chamber 110, the hollow pole 125 and the separation plates 132, 134 remain stationary while the rotary plates 120 rotate. In some embodiments, these three rotary plates 120 rotate at the same speed and are controlled collectively. In some embodiments, these three rotary plates 120 rotate at different speeds, and are controlled individually. In some embodiments, a rotating speed of the rotary plate 120 is about or less than 0.5 rpm. In some embodiments, from the top view of FIG. 1B, these three rotary plates 120 rotate all in a clockwise direction around a central axis of the reaction chamber 110.

As seen in FIG. 1A and FIG. 1B, the catalysts 140 are depicted as catalyst containing particles and are distributed evenly on the surface of the rotary plates 120 and distributed between the through holes 122. It is possible that the catalysts 140 are provided in the forms of particles, powders, granules, gels or sol-gels. Through the catalyst(s) 140, the bonding energy of the exhaust gas F can be lowered, leading to more efficient treatment or processing of the exhaust gas F. In some embodiments, the catalyst 140 includes metal phosphates, metal oxides, zeolite, mixtures thereof, or combinations thereof. It should be noted that different types of catalysts may be utilized for treating different types of exhaust gas F, and more than one type of catalyst may be used for the catalysts 140. In some embodiments, when the exhaust gas F includes fluorinated gases such as NF₃, C₄F₈ or CF₄, the catalysts 140 include at least metal phosphates, such as aluminum phosphate (AlPO₄), aluminum phosphate added with a small amount of rare earth elements (such as cerium (Ce), gadolinium (Gd), lanthanum (La), neodymium (Nd), praseodymium (Pr)), or aluminum phosphate aluminum oxide mixtures (AlPO₄—Al₂O₃). For example, using the catalyst of aluminum phosphate added with rare earth elements and water vapor, the destruction removal efficiency of CF₄ from the exhaust gas (the abatement efficiency) can be significantly improved. In some embodiments, when the exhaust gas F includes fluorinated gases such as CF₄, the catalysts 140 include at least aluminum based catalyst such as aluminum oxide added with other elements of zinc (Zn), zirconium (Zr), gallium (Ga), or nickel (Ni) can achieve great CF₄ destruction removal efficiency. In some embodiments, when the exhaust gas F includes nitrogen-containing greenhouse gases such as nitrous oxide (NOx) or nitrogen fluorides, the catalysts 140 include metal oxides such as aluminum oxide, titanium oxide, tungsten oxide, vanadium oxide, mixtures thereof or zeolite.

The circulating tank 170 is filled with a carrying fluid containing a reactivating agent or a regenerating agent 172, as the source responsible for supplying the regenerating agent 172 to the reactivation area of the rotary plate 120. Herein, the regenerating agent 172 may be depicted as a fluid containing the regenerating agent or regenerating agent solution in the figures, however, it is not intended to limit the form of the regenerating agent. The pump 180 is connected to the circulating tank 170 to drive the fluid for circulating and for supplying the regenerating agent 172 into the sprayers 160. As seen in FIG. 1A, and FIG. 1D, driven by the pump 180, the regenerating agent 172 flows from the tank 170 through the fluid pipe 127 into the sprayers 160 (flow direction shown in arrows) and then is sprayed from the nozzles 162 of the sprayers 160 onto the catalysts 140 distributed over the reactivation area of the rotary plate 120. Later, the carrying fluid, dripping down from the through holes 122 of the rotary plates 120, flows back into the circulating tank 170 via the pipe T3. Depending on the kind of catalysts is used, suitable regenerating agent(s) may be selected along with various treating conditions. In some embodiments, when the catalysts 140 include a metal oxide, such as Al₂O₃, the regenerating agent 172 includes sodium hydroxide (NaOH), which is able to reactivate and regenerate the catalytic activity of the catalysts 140. In some embodiments, when the catalysts 140 include a metal oxide, such as TiO₂, the regenerating agent 172 includes hydrogen chloride (HCl) in an aqueous solution, HCl (aq.), so that the catalytic activity is recovered through water washing/acid washing or immersion of the regenerating agent solution. In some embodiments, when the catalyst 140 is or include zeolite, the regenerating agent 172 includes water vapor, such as water vapor of about 5% in volume (5% vol. water vapor), and the catalyst 140 is reactivated under the reaction with water vapor at the temperature of about 230~300°C.

Referring to the flow direction shown in the bold arrows in FIG. 1A and FIG. 1D, th exhaust gas F enters the inlet 112 of the reaction chamber 110 through the pipe T1 and passes downward through the adsorption/reaction areas of each of the rotary plates 120, into the pipe 115, flows through the desorption areas of the rotary plates 120, and later flows out of the reaction chamber through the outlet 114 into the pipe T2. The exhaust gas F flows through the desorption areas of the rotary plates 120 and then leaves the reaction chamber 110 through the outlet 114 into the pipe T2, without entering the reactivation areas at all.

The recycling of the catalysts 140 is achieved through the rotation of the rotary plate 120 starting from the catalysts 140 located on the rotary plate 120 in the adsorption area where the catalysts 140 absorb and react with the exhaust gas F and become saturated and gradually lose catalytic activity. Following the rotation, the catalysts 140 rotating along with the rotating rotary plate 120 moves into the desorption area where desorption occurs through heating by the heater 150. Following the rotation, the catalyst 140 rotating along with the rotating rotary plate 120 moves into the reactivation area where the catalysts 140 react with the regenerating agent 172 that are sprayed onto the catalysts 140 and the catalytic activities of the catalysts are reactivated (regenerated). Finally, the catalysts 140 rotating along with the rotating rotary plate 120 moves back to the adsorption area, thereby completing the recycling of the catalysts 140. Within the adsorption/reaction areas, the exhaust gas F (the target gas such as the greenhouse gas contained in the gas) is adsorbed to and reacted with the catalysts 140 in the adsorption/reaction area of each rotary plate 120. Afterwards, after passing through the adsorption/reaction areas and reaction with the catalysts 140, the remaining exhaust gas F that has been processed keeps flowing through the connecting pipe 115 at the bottom of the reaction chamber 110, then flowing through the desorption areas of the rotary plates 120 passing through the through holes 122 of the rotary plates 120. Within the desorption areas and the connecting pipe 115, the exhaust gas F is heated by the heater 150, so that desorption occurs for the catalysts 140 in the desorption areas.

FIG. 1E is a schematic top view illustrating an apparatus for processing exhaust gas accordance with some embodiments of the disclosure. Referring to FIG. 1E, in addition to utilizing the aforementioned rotation mechanism of the rotary plates 120, the recycling of the catalysts 140 can also be achieved by utilizing a conveyor belt or a long chain 120a having porous and with catalyst 140 thereon or other available means may be applied to move the catalysts 140 through rotating the carrier over a period of time (a cycle). In some embodiments, the carrier (i.e. the conveyor belt or the long chain 120a) with catalysts 140 thereon moves in the absorption area (i.e. adsorption/reaction area A1), the desorption area A2 and the reactivation area A3 in sequence repeatedly. In some embodiments, from the top view of FIG. 1E, the conveyor belt or the long chain 120a rotates in a counterclockwise direction around a central axis of the reaction chamber 110. Referring to the flow direction shown in the bold arrows in FIG. 1E, the exhaust gas F enters the reaction chamber 110 and passes downward through the adsorption/reaction area A1 of, flows through the desorption area A2, and later flows out of the reaction chamber 110. The exhaust gas F flows through the desorption area A2 and then leaves the reaction chamber 110 without entering the reactivation area A3 at all.

The design of incorporation of rotary plates with through holes in the aforementioned scrubber apparatus 100a for processing exhaust gas F in the embodiments alleviates catalyst clogging and catalyst poisoning. By way of providing rotary plates with through holes, the recycling of the catalysts is achieved through continuing and ongoing reactivation of the catalysts using suitable regenerating agents under workable conditions, leading to longer lifetime for the catalysts and thorough capture of the target greenhouse gases. Since the catalysts can abate the greenhouse gases more efficiently from the exhaust gas with lower thermal budgets, the semiconductor products process through the processing of the aforementioned scrubber apparatus can be fabricated in a more energy-saving way and with lower costs.

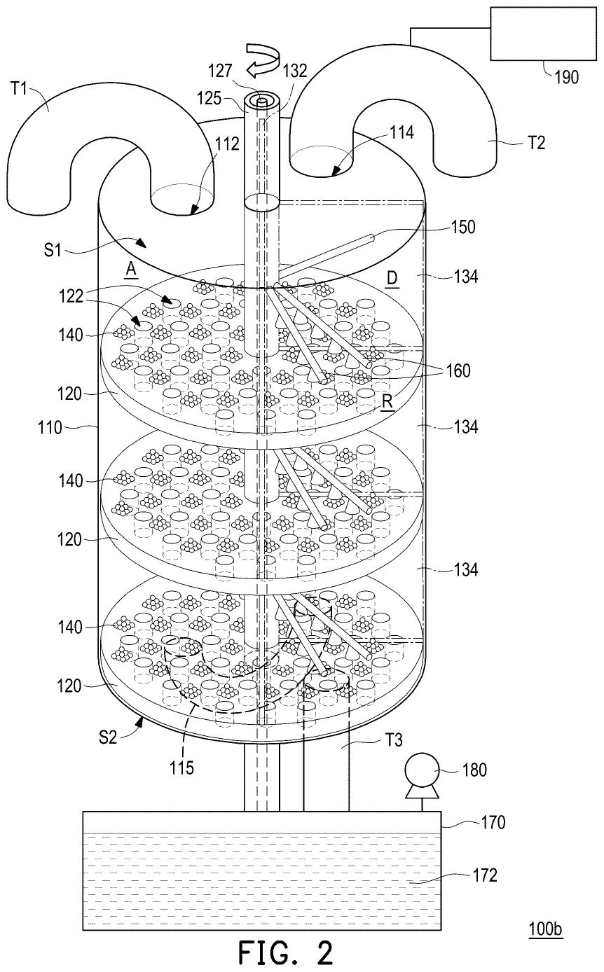

FIG. 2 is schematic illustrating an apparatus for processing exhaust gas in accordance with some embodiments of the disclosure. For clarity, the separation plates 132, 134 in FIG. 2 are represented by dashed lines, and the interior of the reaction chamber 110 is shown in perspective. Referring to FIG. 2, the apparatus 100 b for processing exhaust gas F in FIG. 2 is similar to the apparatus 100a for processing exhaust gas F in FIG. 1A, so similar elements are denoted by the same reference numeral and the detailed description thereof is omitted herein. The difference between the apparatus 100b for processing exhaust gas F in FIG. 2 and the apparatus 100a for processing exhaust gas F in FIG. 1A lies in that the apparatus 100b for processing exhaust gas F further includes a heat exchanger 190 disposed adjacent to the outlet 114 of the reaction chamber 110, capable of recovering heat and redirecting it back to the desorption area D, thereby conserving energy consumption. In some embodiments, the heat exchanger 190 can be considered as a return air system, which allows the hot air to be directed back into the reaction chamber 110 to circulate with the rotating plate 120.

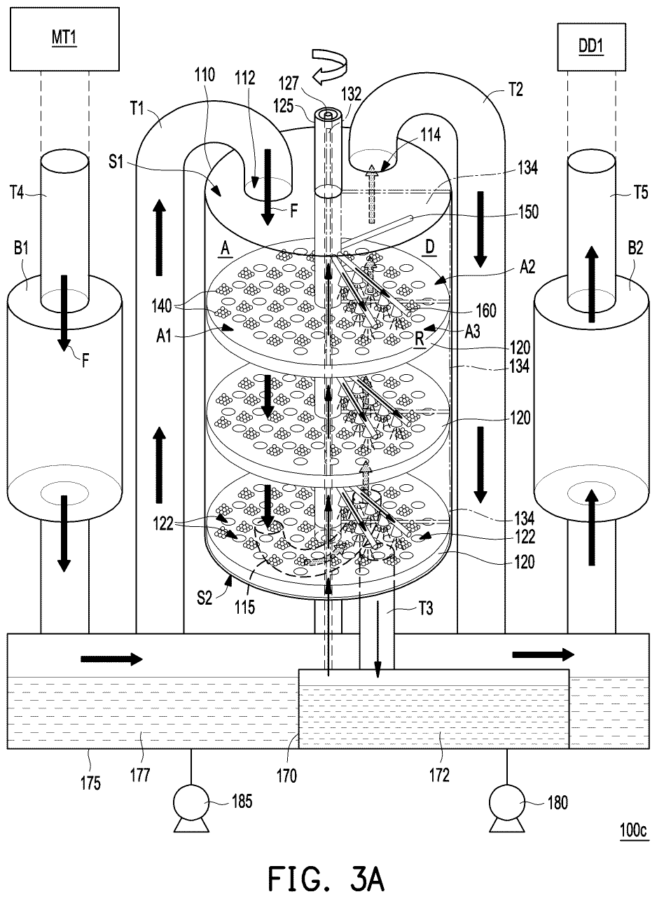

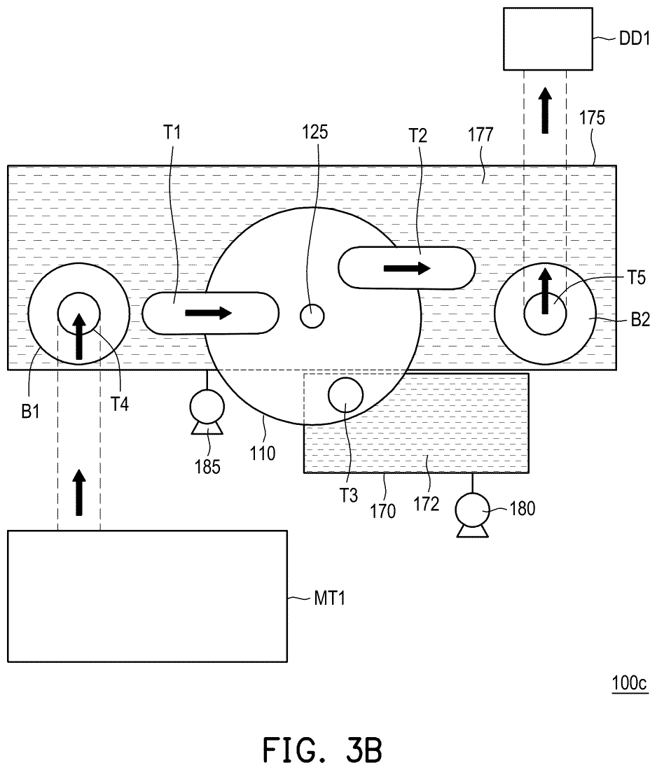

FIG. 3A is a schematic view illustrating a system for processing exhaust gas in accordance with some embodiments of the disclosure. FIG. 3B is a schematic top view illustrating the arrangement of the system in FIG. 3A. For illustration purposes, the reaction chamber 110 is depicted as being transparent to show the interior arrangements of the rotary plates 120 and the catalysts 140, and the separation plates 132, 134 in FIG. 3A are represented by dashed lines. The same or similar elements will be labelled with the same reference numbers or labels in the figures, and detailed descriptions will not be repeated for simplification purposes. It is understood that the same or similar functions, formation methods and materials may be applied for the same or similar elements.

Referring to FIG. 3A and FIG. 3B, a system 100c for treating/processing exhaust gas F includes the reaction chamber 110, a first scrubber B1, a second scrubber B2, one or more rotary plates 120, the separation plates 132, 134, the catalysts 140, the heater 150, the sprayers 160, a first tank 170, a first pump 180, a second tank 175, and a second pump 185. The first scrubber B1 is connected to the inlet 112 of the reaction chamber 110, and the second scrubber B2 is connected to the outlet 114 of the reaction chamber 110. The first scrubber B1 of the system 100c is further connected to a microfabrication tool MT1 for receiving the exhaust gas F expelled from the microfabrication tool MT1, and the second scrubber B2 of the system 100c is further connected to a drain DD1 for discharging the treated exhaust gas F. As the reaction chamber 110 is similar to the reaction chamber 110 described previously and includes the same or similar elements and parts, certain details will not be repeated again. The first scrubber B1 is connected to the inlet 112 of the reaction chamber 110 through the pipe T1. The main function of the first scrubber B1 is to remove dusts from the exhaust gas F, as a pretreatment. The second scrubber B2 is connected to the outlet 114 of the reaction chamber 110 through the pipe T2. The primary function of the second scrubber B2 is to reduce water-soluble gases (such as acidic gases or HF) produced after being treated or processed in the reaction chamber 110.

Three rotary plate 120 with the through holes 122 are disposed inside the reaction chamber 110. The through holes 122 penetrating through the rotary plates 120 are designed to facilitate gas flow and even and uniform gas distribution over the plate surface to increase the contact with the catalysts 140. In some embodiments, a total area of all the through holes 122 over the area of the rotary plate 120 is about or greater than 10% (i.e. 10% of the area of the rotary plate 120). In some embodiments, at least one of the rotary plates 120 is a multi-hole plate including the through holes 122 of about the same size. Herein, it is possible that the rotary plates 120 are positioned in the reaction chamber 110 with different intervals or stacked upon each other, and the thickness and the size of the rotary plate 120 are not particularly limited as long as they are able to support the catalysts 140 and work under the gas flow.

As seen in FIG. 3A, the separation plates 132, 134 are disposed uprightly on the rotary plates 120 (i.e. substantially perpendicular to the plate surface). In some embodiments, the reaction chamber 110 is separated by separation plates 132, 134 fixed to the sidewall(s) of the hollow pole 125 into multiple divisions of variable sizes. In FIG. 3A, in some embodiments, among the space between the top side of the reaction chamber 110 and the uppermost rotary plate 120 (or any two most adjacent rotary plates 120), two separation plates 132 and one isolation plate 134 divide the space into three parts or three divisions A, D, R. For each rotary plate 120, the first division area A1 is defined between the two separation plates 132, and the second division area A2 and the third division area A3 are respectively defined between the isolation plate 134 and the upper and lower separation plates 132. Considering the space between the adjacent rotary plates 120, the first division A (above the first division area A1) is defined between the two separation plates 132, the second division D (above the second division area A2) is defined between the isolation plate 134 and the upper separation plate 132, and the third division R (above the third division area A3) is defined between the isolation plate 134 and the lower separation plate 132 in the reaction chamber 110. For the catalysts 140 used during the gas treatment, the first division area A1 is an adsorption/reaction area, the second division area A2 is a desorption area, and the third division area A3 is a reactivation area.

The catalysts 140 are depicted as catalyst containing particles and are distributed evenly on the surface of the rotary plates 120 and distributed beside and between the through holes 122. Through the catalyst(s) 140, the bonding energy of the exhaust gas F can be lowered, leading to more efficient treatment or processing of the exhaust gas F. In some embodiments, the catalyst 140 includes metal phosphate, metal oxide, zeolite, mixtures thereof, or combinations thereof. It should be noted that different types of catalysts may be utilized for treating different types of exhaust gas F, and more than one type of catalyst may be used for the catalysts 140. The heater 150 is arranged within the space of the second division D right above the second division area A2, and the sprayers 160 are arranged within the space of the third division R right above the third division area A3. In some embodiments, one heater 150 and at least two sprayers 160 are arranged above each of the rotary plates 120. In other words, for the multi-layer design of the system 100c, multiple sets of the heater 150 and the sprayers 160 are arranged correspondingly for the multi-leveled rotary plates 120.

In FIG. 3A, in some embodiments, the first tank 170 is filled with a first working fluid containing a reactivating agent or regenerating agent 172, driven by the first pump 175 for supplying the regenerating agent 172 to the reactivation area of the rotary plate 120. As seen in FIG. 3A, driven by the first pump 175, the regenerating agent 172 flows from the first tank 170 through the fluid pipe 127 into the sprayers 160 (flow direction shown in arrows) and then is sprayed from the nozzles 162 of the sprayers 160 onto the catalysts 140 distributed over the reactivation area of the rotary plate 120. Later, dripping down from the through holes 122 of the rotary plates 120, the fluid flows back into the first tank 170 via the pipe T3. In some embodiments, the first tank 170 is a circulating tank, and the regenerating agent 172 includes a regenerant, a reactivating agent and/or a desorption agent.

In some embodiments, when the catalysts 140 include a metal oxide, such as Al₂O₃, the regenerating agent 172 includes sodium hydroxide (NaOH), which is able to reactivate and regenerate the catalytic activity of the catalysts 140. In some embodiments, when the catalysts 140 include a metal oxide, such as TiO₂, the regenerating agent 172 includes hydrogen chloride (HCl) in an aqueous solution, so that the catalytic activity is recovered through water washing/acid washing or immersion of the regenerating agent solution. In some embodiments, when the catalyst 140 is or include zeolite, the regenerating agent 172 includes water vapor, such as water vapor of about 5% in volume (5% vol. water vapor), and the catalyst 140 is reactivated under the reaction with water vapor at the temperature of about 230~300°C. The second tank 175 is filled with a second working fluid 177 containing a water and/or an acid or a base, and connected to the first scrubber B1 and the second scrubber B2, to supply the second working fluid 177 to the first scrubber B1 and the second scrubber B2. Driven by the second pump 185 connected to the second tank 175, the second working fluid 177 is circulated between the first scrubber B1 and the second tank 175 and between the second scrubber B2 and the second tank 175 through the connecting pipes. Within the first scrubber B1, the second working fluid 177 is pumped upward from the second tank 175 into the first scrubber B1 and sprinkled over the first scrubber B1 to wash off dusts from the exhaust gas F, and then the second working fluid 177 drips back to the second tank 175 for circulation. In some embodiment, the second tank 175 is equipped with a liquid level control for replenishing fresh second working fluid 177.

In some embodiments, the system 100c is connected to the microfabrication tool MT1 for example, an etching chamber, and the exhaust gas F, for example, is the exhaust gas from the etching process performed in the etching chamber, including fluorinated gases or perfluorocarbon (PFC) gases, such as CF₄, C₂F₆, C₃F₈, C₄F₈, etc. In some embodiments, the system 100c is connected to the microfabrication tool MT1, for example, a deposition chamber, and the exhaust gas F, for example, is the exhaust gas exhausted from film deposition and cleaning processes used for thin film manufacturing (such as chemical vapor deposition (CVD)) in the deposition chamber, including nitrogen-containing greenhouse gases, such as nitrous oxide (N₂O), nitrogen trifluoride (NF₃), etc.

Referring to the flow direction (in bold arrows) in FIG. 3A, the exhaust gas F enters the first scrubber B1 via the pipe T4, passes through the first scrubber B1, moves through the second tank 175, into the pipe T1 and then flows into the reaction chamber 110. The exhaust gas F enters the inlet 112 of the reaction chamber 110 from the pipe T1 and passes downward through adsorption/reaction areas of the rotary plates 120, into the pipe 115, flows through the desorption areas of the rotary plates 120, and later flows out of the reaction chamber 110 through the outlet 114 into the pipe T2. The exhaust gas F flows through the desorption areas of the rotary plates 120 and then leaves the reaction chamber 110 through the outlet 114 into the pipe T2, without entering the divisions above the reactivation areas at all. The recycling of the catalysts 140 is achieved through the rotation of the rotary plate 120, starting from the catalysts 140 located on the rotary plate 120 in the adsorption area where the catalysts 140 absorb and react with the exhaust gas F and become saturated and gradually lose catalytic activity. Following the rotation, the catalysts 140 rotating along with the rotating rotary plate 120 moves into the desorption area where desorption occurs through heating by the heater 150. Following the rotation, the catalyst 140 rotating along with the rotating rotary plate 120 moves into the reactivation area where the catalysts 140 react with the regenerating agent 172 that are sprayed onto the catalysts 140 and the catalytic activities of the catalysts are reactivated (regenerated). Finally, the catalysts 140 rotating along with the rotating rotary plate 120 moves back to the adsorption area, thereby completing the recycling of the catalysts 140. Within the adsorption/reaction areas, the exhaust gas F (the target gas such as the greenhouse gas contained in the gas) is adsorbed or absorbed by the catalysts 140 in the adsorption/reaction area of each rotary plate 120. Afterwards, after passing through the adsorption/reaction areas and reaction with the catalysts 140, the remaining exhaust gas F that has been treated keeps flowing through the connecting pipe 115 at the bottom of the reaction chamber 110, then flowing through the desorption areas of the rotary plates 120 passing through the through holes 122 of the rotary plates 120. Within the desorption areas and the connecting pipe 115, the exhaust gas F is heated by the heater 150, so that desorption occurs for the catalysts 140 in the desorption areas.

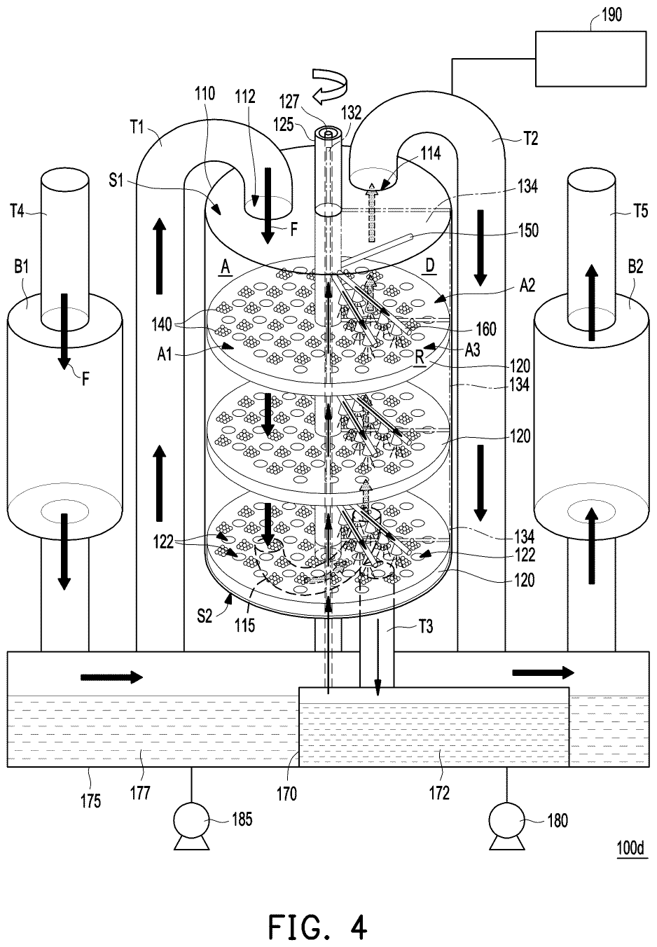

FIG. 4 is a schematic view illustrating a system for processing exhaust gas in accordance with some embodiments of the disclosure. For simplification, the possible connection with a microfabrication tool and a drain are omitted in FIG. 4. Referring to FIG. 4, the system 100d for processing exhaust gas F in FIG. 4 is similar to the system 100c for processing exhaust gas F in FIG. 3A, so similar elements are denoted by the same reference numeral and the detailed description thereof is omitted herein. The main difference between the system 100d in FIG. 4 and the system 100c for processing exhaust gas F in FIG. 3A lies in that the system 100d for processing exhaust gas F further includes a heat exchanger 190 disposed adjacent to the outlet 114 of the reaction chamber 110, capable of recovering heat and redirecting it back to the desorption area D, thereby further cutting/reducing energy consumption. In some embodiments, the heat exchanger 190 includes a return air system, which allows the hot air to be directed back into the reaction chamber 110 for promoting the heating for the rotating plates 120.

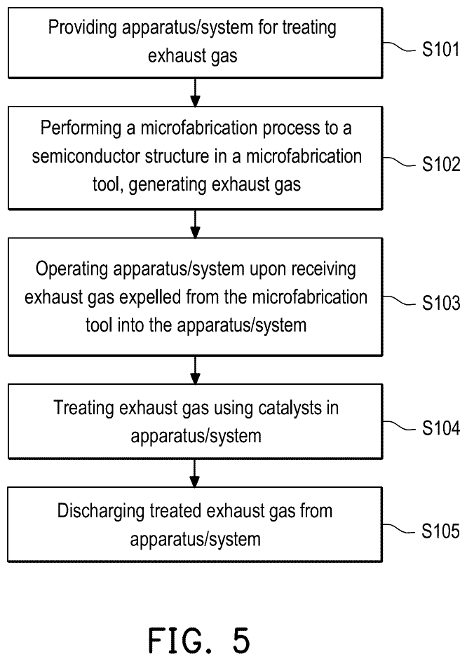

FIG. 5 is the flow chart showing the steps of the method for processing exhaust gas according to some exemplary embodiments. Referring to FIG. 5, the method for processing an exhaust gas includes the following steps. Firstly, according to some embodiment, in step S101, an apparatus/a system for treating an exhaust gas is provided. The aforementioned apparatus/system for treating the exhaust gas may be provided and incorporated. In some embodiments, the apparatus for processing exhaust gas may be the apparatus 100a as shown i n FIG. 1A, which includes the reaction chamber 110, one or more rotary plates 120, the separation plates 132, 134, the catalysts 140, the heater 150, the sprayers 160, the circulating tank 170 and the pump 180. In some embodiments, the apparatus for processing exhaust gas may be the apparatus 100b as shown in FIG. 2, which includes the reaction chamber 110, one or more rotary plates 120, the separation plates 132, 134, the catalysts 140, the heater 150, the sprayers 160, the circulating tank 170, the pump 180, and the heat exchanger 190. In some embodiments, the system for processing exhaust gas may be the system 100c as shown i n FIG. 3A, which includes the reaction chamber 110, the first scrubber B1, the second scrubber B2, one or more rotary plates 120, the separation plates 132, 134, the catalysts 140, the heater 150, the sprayers 160, the first tank 170, the first pump 180, the second tank 175, and the second pump 185. In some embodiments, the system for processing exhaust gas may be the system 100d as shown in FIG. 4, which includes the reaction chamber 110, the first scrubber B1, the second scrubber B2, one or more rotary plates 120, the separation plates 132, 134, the catalysts 140, the heater 150, the sprayers 160, the first tank 170, the first pump 180, the second tank 175, the second pump 185 and the heat exchanger 190.

Next, according to some embodiments, in Step S102, a microfabrication process is performed to a semiconductor structure in a microfabrication tool and generating the exhaust gas. In some embodiments, the semiconductor structure includes or is a semiconductor wafer, including a silicon bulk wafer, a silicon on insulator (SOI) wafer or a gallium arsenide wafer. In some embodiments, the semiconductor structure includes or is a semiconductor die, a packaged semiconductor die, a package component/subunit or a package structure. In some embodiments, the exhaust gas F is or includes, gas exhausted from microfabrication or one or more semiconductor fabrication or processing steps of a semiconductor structure. Depending on the type of semiconductor processing step(s) performed, when the microfabrication step is completed, residual reaction gases and byproduct gases generated during the processing (i.e. microfabrication step) will be exhausted out of the processing tool chamber (microfabrication tool chamber) and the exhaust gas will be treated by the apparatus for processing exhaust gas. In some embodiments, the apparatus 100a/100b or the system 100c/100d is a local scrubber device/apparatus/system connected to an etching chamber, and the exhaust gas F, for example, is the exhaust gas from the etching process performed in the etching chamber, including fluorinated gases or perfluorocarbon (PFC) gases, such as CF₄, C₂F₆, C₃F₈, C₄F₈, etc. In some embodiments, the apparatus 100a/100b or the system 100c/100d is a local scrubber device/apparatus/system connected to a deposition chamber, and the exhaust gas F, for example, is the exhaust gas exhausted from film deposition and cleaning processes used for thin film manufacturing (such as chemical vapor deposition (CVD)) in the deposition chamber, including nitrogen-containing greenhouse gases, such as nitrous oxide (N₂O), nitrogen trifluoride (NF₃), etc.

Next, according to some embodiments, in Step S103, the apparatus/the system is operated upon receiving the exhaust gas expelled from the microfabrication tool into the apparatus/the system. The operation of the apparatus 100a/100b or the system 100c/100d includes operating certain or all of the elements or parts to work in collaboration, including allowing the entering of the exhaust gas F that is expelled from the microfabrication tool MT1 into the reaction chamber 110 and rotating the rotary plates 120. In some embodiments, the rotary plate 120 is rotated in a first speed. In some embodiments, the first speed of the rotary plate 120 is about or less than 0.5 rpm. In some embodiments, these three rotary plates 120 rotate all in a clockwise direction. Upon the rotation of the rotary plates 120, the catalysts 140 on the rotary plate 120 are exposed to the exhaust gas F and reacted with the exhaust gas F.

Next, according to some embodiments, in Step S104, the exhaust gas is treated using the catalysts in the apparatus/the system. The catalysts 140 are depicted as catalyst containing particles and are distributed evenly on the surface of the rotary plates 120 and distributed between the through holes 122. Through the catalyst(s) 140, the bonding energy of the exhaust gas F can be lowered, leading to more efficient treatment or processing of the exhaust gas F. Firstly, the recycling of the catalysts 140 is achieved through the rotation of the rotary plate 120, starting from the catalysts 140 located on the rotary plate 120 in the adsorption area where the catalysts 140 absorb and react with the exhaust gas F and become saturated and gradually lose catalytic activity. Next, following the rotation, the catalysts 140 rotating along with the rotating rotary plate 120 moves into the desorption area where desorption occurs through heating by the heater 150. Herein, the catalysts 140 are heated in the desorption area D by the heater 150. Next, following the rotation, the catalyst 140 rotating along with the rotating rotary plate 120 moves into the reactivation area where the regenerating agent 172 is supplied to the catalysts 140 in the reactivation area R, wherein the catalysts 140 are reacted with the regenerating agent 172 and are reactivated. Finally, the catalysts 140 rotating along with the rotating rotary plate 120 moves back to the adsorption area, thereby completing the recycling of the catalysts 140. Within the adsorption/reaction areas, the exhaust gas F (the target gas such as the greenhouse gas contained in the gas) is adsorbed or absorbed by the catalysts 140 in the adsorption/reaction area of each rotary plate 120. Afterwards, after passing through the adsorption/reaction areas and reaction with the catalysts 140, the remaining exhaust gas F that has been processed keeps flowing through the connecting pipe 115 at the bottom of the reaction chamber 110, then flowing through the desorption areas of the rotary plates 120 passing through the through holes 122 of the rotary plates 120. Within the desorption areas and the connecting pipe 115, the exhaust gas F is heated by the heater 150, so that desorption occurs for the catalysts 140 in the desorption areas.

Finally, according to some embodiments, in Step S105, the treated exhaust gas is discharged from the apparatus/the system. In some embodiments, after receiving the exhaust gas F into the first division A, reacting with the catalysts 140 within the first division A, and flowing into the second division D, the exhaust gas F leaves the reaction chamber 110 from the outlet 114, going through the second tank 177 and the second scrubber B2, the exhaust gas F is discharged into the drain DD1.

According to some embodiments, an apparatus for processing an exhaust gas includes a reaction chamber, a rotary plate, a first separation plate, a second separation plate and a third separation plate, catalysts, a heater, sprayers, and a fluid tank. The reaction chamber has a first side, a second side opposite to the first side, an inlet, an outlet and a connecting pipe, wherein the inlet and the outlet are located on the first side, and the connecting pipe is located on the second side. The rotary plate is disposed in reaction chamber and has through holes penetrating through the rotary plate, wherein the rotary plate is configured to rotate in a first direction around a central axis of the reaction chamber. The first separation plate, the second separation plate and the third separation plate are disposed in the reaction chamber and disposed uprightly on the rotary plate. The first and second separation plates define and segregate a first division in the reaction chamber and a first division area on the rotary plate. The second and third separation plates define and segregate a second division in the reaction chamber and a second division area on the rotary plate. The first and third separation plates define and segregate a third division in the reaction chamber and a third division area on the rotary plate. The connecting pipe connects the first division and the second division. The first division area is an adsorption/reaction area, the second division area is a desorption area, and the third division area is a reactivation area. The catalysts are distributed on the rotary plate over the first, second and third division areas and beside and between the plurality of through holes. The heater is disposed inside the second division of the reaction chamber and located above the second division area. The sprayers are disposed in the third division of the reaction chamber and located above the third division area. The fluid tank contains a fluid including a regenerating agent and for supplying the regenerating agent into the third division of the reaction chamber over the catalysts in the third division area.

According to some embodiments, a system for processing exhaust gas includes a reaction chamber, a carrier and catalysts. The reaction chamber has an absorption area, a desorption area and a reactivation area. The carrier is disposed in the reaction chamber and has a plurality of through holes, wherein the carrier moves in the absorption area, the desorption area and the reactivation area in sequence repeatedly. The catalysts are distributed on the carrier, wherein the exhaust gas enters the reaction chamber, passes through the absorption area and the desorption area, and leaves the reaction chamber.

According to some embodiments, a method for processing exhaust gas including providing an apparatus/a system for treating an exhaust gas, performing a microfabrication process to a semiconductor structure in a microfabrication tool and generating the exhaust gas; operating the apparatus/the system upon receiving the exhaust gas expelled from the microfabrication tool into the apparatus/the system; treating exhaust gas using catalysts in the apparatus/the system; and discharging treated exhaust gas from the apparatus/system. The apparatus includes a rotary plate, a first separation plate, a second separation plate and a third separation plate, catalysts, a heater, a plurality of sprayers, and a fluid tank. The rotary plate is disposed in reaction chamber and has a plurality of through holes penetrating through the rotary plate, wherein the rotary plate is configured to rotate in a first direction around a central axis of the reaction chamber. The first separation plate, the second separation plate and the third separation plate are disposed in the reaction chamber and disposed uprightly on the rotary plate. The first and second separation plates define and segregate a first division in the reaction chamber and a first division area on the rotary plate. The second and third separation plates define and segregate a second division in the reaction chamber and a second division area on the rotary plate. The first and third separation plates define and segregate a third division in the reaction chamber and a third division area on the rotary plate. The connecting pipe connects the first division and the second division. The first division area is an adsorption/reaction area, the second division area is a desorption area, and the third division area is a reactivation area. The catalysts are distributed on the rotary plate over the first, second and third division areas and beside and between the plurality of through holes. The heater is disposed inside the second division of the reaction chamber and located above the second division area. The sprayers are disposed in the third division of the reaction chamber and located above the third division area. The fluid tank contains a fluid comprising a regenerating agent and for supplying the regenerating agent into the third division of the reaction chamber over the catalysts in the third division area.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An apparatus for processing an exhaust gas, comprising:
a reaction chamber, having a first side, a second side opposite to the first side, an inlet, an outlet and a connecting pipe, wherein the inlet and the outlet are located on the first side, and the connecting pipe is located on the second side;
a rotary plate, disposed in reaction chamber and having a plurality of through holes penetrating through the rotary plate, wherein the rotary plate is configured to rotate in a first direction around a central axis of the reaction chamber;
a first separation plate, a second separation plate and a third separation plate, disposed in the reaction chamber and disposed uprightly on the rotary plate, wherein the first and second separation plates define and segregate a first division in the reaction chamber and a first division area on the rotary plate, the second and third separation plates define and segregate a second division in the reaction chamber and a second division area on the rotary plate, and the first and third separation plates define and segregate a third division in the reaction chamber and a third division area on the rotary plate, the connecting pipe connects the first division and the second division, the first division area is an adsorption/reaction area, the second division area is a desorption area, the third division area is a reactivation area;
catalysts, distributed on the rotary plate over the first, second and third division areas and beside and between the plurality of through holes;
a heater, disposed inside the second division of the reaction chamber and located above the second division area;
a plurality of sprayers, disposed in the third division of the reaction chamber and located above the third division area; and
a fluid tank, containing a fluid comprising a regenerating agent and for supplying the regenerating agent into the third division of the reaction chamber over the catalysts in the third division area.

2. The apparatus of claim 1, wherein the inlet is connected to a microfabrication tool for receiving an exhaust gas expelled by the microfabrication tool, and the exhaust gas entering the first division of the reaction chamber from the inlet is adsorbed or absorbed to the catalysts in the adsorption/reaction area of the rotary plate.

3. The apparatus of claim 2, wherein a flow direction of the exhaust gas inside the reaction chamber is from the first division, through the connecting pipe to the second division.

4. The apparatus of claim 3, wherein the exhaust gas entering the second division of the reaction chamber passes through the desorption area of the rotary plate through the plurality of through holes and is heated by the heater for desorption.

5. The apparatus of claim 2, wherein the catalysts in the reactivation area are regenerated through reaction with the regenerating agent supplied into the third division of the reaction chamber, the exhaust gas comprises a fluorinated gas, and the catalysts comprise metal phosphates, metal oxides, zeolite, or mixtures thereof.

6. The apparatus of claim 1, further comprising a pump connected to the fluid tank for driving the fluid in the fluid tank, and a heat exchanger disposed adjacent to the outlet of the reaction chamber.

7. The apparatus of claim 1, wherein a total area of the plurality of through holes of the rotary plate is about or greater than 10% of a total area of the rotary plate.

8. A system for processing an exhaust gas, comprising:
a reaction chamber, having an absorption area, a desorption area and a reactivation area;
a carrier, disposed in the reaction chamber and having a plurality of through holes, wherein the carrier moves in the absorption area, the desorption area and the reactivation area in sequence repeatedly; and
catalysts, distributed on the carrier,
wherein the exhaust gas enters the reaction chamber, passes through the absorption area and the desorption area, and leaves the reaction chamber.

9. The system of claim 8, wherein the reaction chamber has a first side, a second side opposite to the first side, an inlet, an outlet, and a connecting pipe, the inlet and the outlet are located on the first side, and the connecting pipe is located on the second side, the inlet is connected to a microfabrication tool for receiving the exhaust gas expelled by the microfabrication tool, and the exhaust gas entering the absorption area of the reaction chamber from the inlet is adsorbed or absorbed to the catalysts on the carrier.

10. The system of claim 8, further comprising:
a heater, disposed inside the desorption area of the reaction chamber and located above the desorption area.

11. The system of claim 10, wherein the exhaust gas entering the desorption area of the reaction chamber by passing through the plurality of through holes of the carrier and is heated by the heater for desorption.

12. The system of claim 8, wherein the exhaust gas comprises a fluorinated gas.

13. The system of claim 8, wherein the catalysts comprise metal phosphates, metal oxides, zeolite, or mixtures thereof.

14. The system for processing exhaust gas of claim 8, further comprising:
a heat exchanger, disposed adjacent to an outlet of the reaction chamber.

15. The system of claim 8, further comprising:
a fluid tank, containing a fluid comprising a regenerating agent and for supplying the regenerating agent into the reactivation area of the reaction chamber over the catalysts in the reactivation area.

16. The system of claim 15, further comprising:
a pump connected to the fluid tank for driving the fluid in the fluid tank.

17. The system of claim 8, wherein a total area of the plurality of through holes of the carrier is about or greater than 10% of a total area of the carrier.

18. A method for processing an exhaust gas, comprising:
providing an apparatus/a system, wherein the apparatus/the system comprises:
a rotary plate, disposed in reaction chamber and having a plurality of through holes penetrating through the rotary plate, wherein the rotary plate is configured to rotate in a first direction around a central axis of the reaction chamber;
a first separation plate, a second separation plate and a third separation plate, disposed in the reaction chamber and disposed uprightly on the rotary plate, wherein the first and second separation plates define and segregate a first division in the reaction chamber and a first division area on the rotary plate, the second and third separation plates define and segregate a second division in the reaction chamber and a second division area on the rotary plate, and the first and third separation plates define and segregate a third division in the reaction chamber and a third division area on the rotary plate, the connecting pipe connects the first division and the second division, the first division area is an adsorption/reaction area, the second division area is a desorption area, the third division area is a reactivation area;
catalysts, distributed on the rotary plate over the first, second and third division areas and beside and between the plurality of through holes;
a heater, disposed inside the second division of the reaction chamber and located above the second division area;
a plurality of sprayers, disposed in the third division of the reaction chamber and located above the third division area; and
a fluid tank, containing a fluid comprising a regenerating agent and for supplying the regenerating agent into the third division of the reaction chamber over the catalysts in the third division area;
performing a microfabrication process to a semiconductor structure in a microfabrication tool and generating an exhaust gas;
operating the apparatus/the system upon receiving the exhaust gas expelled from the microfabrication tool into the apparatus/the system;
treating the exhaust gas using the catalysts in the apparatus/the system; and
discharging treated exhaust gas from the apparatus/system.

19. The method of claim 18, wherein the exhaust gas comprises a fluorinated gas, and the catalysts comprise metal phosphates, metal oxides, zeolite, or mixtures thereof.

20. The method of claim 18, wherein the fluid containing the regenerating agent are sprayed onto the catalysts in the reactivation area by the plurality of sprayers.
